(19) United States
(12) Patent Application Publication
(10) Pub. No.: US 2021/0336817 A1
(43) Pub. Date: Oct. 28, 2021

(54) COMMUNICATION CONTROL DEVICE AND TRANSCEIVER FOR A USER STATION OF A SERIAL BUS SYSTEM, AND METHOD FOR COMMUNICATING IN A SERIAL BUS SYSTEM

(71) Applicant: Robert Bosch GmbH, Stuttgart (DE)

(72) Inventors: Arthur Mutter, Neuhausen (DE); Florian Hartwich, Reutlingen (DE); Steffen Walker, Reutlingen (DE)

(21) Appl. No.: 17/234,161

(22) Filed: Apr. 19, 2021

(30) Foreign Application Priority Data
Apr. 27, 2020 (DE) 102020205278.6

(51) Int. Cl. H04L 12/40; H04B 1/38

(52) U.S. Cl. CPC H04L 12/40; H04L 2012/40215; H04B 1/38

(57) ABSTRACT

A communication control device and a transceiver for a user station of a serial bus system. The communication control device includes a communication control module for generating a transmission signal for controlling a communication of the user station with at least one other user station of the bus system, in which bus system a first communication phase and a second communication phase being used for exchanging messages between user stations of the bus system, an STB terminal for transmitting an operating mode signaling signal to a transceiver designed to transmit the transmission signal onto a bus of the bus system, and an operating mode coding block for generating the operating mode signaling signal from a signal that signals to the transceiver that the transceiver is to be switched into the standby operating mode.

### CROSS REFERENCE

The present application claims the benefit under 35 U.S.C. § 119 of German Patent Application No. DE 102020205278.6 filed on Apr. 27, 2020, which is expressly incorporated herein by reference in its entirety.

### FIELD

The present invention relates to a communication control device and a transceiver for a user station of a serial bus system, and a method for communicating in a serial bus system that operates with a high data rate and a high level of error robustness.

### BACKGROUND INFORMATION

For the communication between sensors and control units, for example in vehicles, a bus system is frequently used in which data are transmitted as messages under the ISO 11898-1:2015 standard, as a CAN protocol specification with CAN FD. The messages are transmitted between the bus users of the bus system, such as the sensor, control unit, transducer, etc.

To allow data to be transmitted at a higher bit rate than with CAN, an option has been provided in the CAN FD message format for changing over to a higher bit rate within a message. The maximum possible data rate is increased beyond a value of 1 Mbit/s by using higher clocking in the area of the data fields. Such messages are also referred to below as CAN FD frames or CAN FD messages. With CAN FD, the useful data length of 8 bytes is increased up to 64 bytes, and the data transmission rates are much higher than with CAN.

In order to transmit data from the transmitting bus user to the receiving bus user more quickly than with CAN FD, a CAN FD successor bus system referred to as CAN XL is presently in development. In addition to a higher data rate in the data phase than with CAN FD, the intent is also to increase the useful data length of up to 64 bytes, achieved thus far with CAN FD. However, the intent is further to maintain the advantages of robustness of a CAN- or CAN FD-based communications network in the CAN FD successor bus system.

It is possible to further increase the higher data rate in the data phase by additionally changing over the physical layer. However, in this case the operating mode of the transceiver, which drives the signals onto the bus and receives them from the bus, must be changed over. For a robust data transmission, the changeover of the operating mode of the transceiver between the individual transmission operating modes and reception operating modes must preferably function without problems.

The more quickly the data are transmitted on the bus, the greater are the demands to be imposed on the quality of the signal that the protocol controller of the user station receives from the bus. For example, if the edge steepness of the bits of the received signal is too low, this may result in bits with excessive asymmetry, and therefore the received signal may possibly not be decoded correctly.

Increasing the edge steepness of the bits of the received signal results in excessively high radiation. This results in costs elsewhere, for example on the circuit board and in the microcontroller for the user station.

### SUMMARY

An object of the present invention, therefore, is to provide a communication control device and a transceiver for a user station of a serial bus system, and a method for communicating in a serial bus system, which solve the above-mentioned problems. In particular, the intent is to provide a communication control device and a transceiver for a user station of a serial bus system, and a method for communicating in a serial bus system in which a high data rate and an increase in the quantity of the useful data per frame may be achieved with a high level of error robustness.

The object may be achieved by a communication control device for a user station of a serial bus system in accordance with an example embodiment of the present invention. In accordance with an example embodiment of the present invention, the communication control device includes a communication control module for generating a transmission signal for controlling a communication of the user station with at least one other user station of the bus system, at least one first communication phase and a second communication phase being used in the bus system for exchanging messages between user stations of the bus system, an STB terminal for transmitting an operating mode signaling signal to a transceiver designed to transmit the transmission signal onto a bus of the bus system, and an operating mode coding block for generating the operating mode signaling signal from a signal that signals to the transceiver that the transceiver is to be switched into the standby operating mode, the operating mode signal signaling to the transceiver the operating mode into which the transceiver is to be switched as a function of the communication on the bus, or whether the transceiver is to be switched into the standby operating mode.

By use of the communication control device it is possible to provide the required fast data transmission with very high bit symmetry for the CAN FD successor bus system, without additional costly terminals between the communication control device and the transceiver.

In accordance with an example embodiment of the present invention, the communication control device is advantageously designed in such a way that the symmetry of the bits in a reception signal RxD, which the transceiver has generated from a signal received from the bus and transmits to the communication control device, is maintained. This applies for the transmission as well as the reception of CAN frames, and thus also for transmission signal TxD.

In addition, a non-return-to-zero (NRZ) encoding may be maintained even during the differential transmission of reception signal RxD between the transceiver and the communication control device (microcontroller). As a result, terminals (pins) with slow edges may now be used for the data transmission between the transceiver and the communication control device (microcontroller). The resulting lower edge steepness of the bits of the received and transmitted signal greatly reduces the radiation of the system.

An edge steepness of the bits of the received and transmitted signal may thus be selected in such a way that the demands on the radiation may be easily met. In addition, the communication control device does not have to use complex line coding methods such as PWM encoding or Manchester encoding to maintain the symmetry of the signal. This reduces the complexity of the data transmission and the decoding of transmission signal TxD and reception signal RxD.

In addition, by use of the communication control device, in one of the communication phases, an arbitration that is available in CAN may be maintained while still increasing the transmission rate considerably compared to CAN or CAN FD. This may be achieved by using two communication phases having different bit rates, and making the start of the second communication phase, in which the useful data are transmitted at a higher bit rate than in the arbitration, clearly identifiable for the transceiver. The transceiver may thus reliably change over from a first communication phase into the second communication phase.

As a result, a substantial increase in the bit rate, and thus in the transmission speed from the transmitter to the receiver, is achievable. However, at the same time a high level of error robustness is ensured. This contributes toward achieving a net data rate of at least 10 Mbps. In addition, the quantity of the useful data may be greater than 64 bytes per frame, in particular up to 2048 bytes per frame, or some other arbitrary length as needed.

The method carried out by the communication control device may also be used when at least one CAN user station and/or at least one CAN FD user station that transmit(s) messages according to the CAN protocol and/or CAN FD protocol are/is present in the bus system.

Advantageous further embodiments of the communication control device are described herein.

In accordance with an example embodiment of the present invention, the operating mode coding block may be designed to encode the operating modes as a state in the operating mode signaling signal. The operating mode coding block is optionally designed to modulate at least one of the operating modes in the operating mode signaling signal using pulse width modulation. According to another option, the operating mode coding block is designed to encode at least one of the operating modes in the operating mode signaling signal as a bit pattern in which the 0 component in relation to the 1 component indicates the operating mode.

The above-described communication control device may also include a first terminal for transmitting the transmission signal to the transceiver in an operating mode of the first communication phase, a second terminal for receiving a digital reception signal from the transceiver in the operating mode of the first communication phase, and an operating mode switching module for switching the transmission direction of the first and second terminals in the second communication phase in the same direction for a differential signal transmission via the first and second terminals.

In accordance with an example embodiment of the present invention, the operating mode switching module, in a first operating mode of the second communication phase, may be designed to switch the first and second terminals to output and generate an inverse signal from the transmission signal, and to output the transmission signal to the first terminal and output the digital transmission signal inverse thereto to the second terminal. Additionally or alternatively, the operating mode switching module, in a second operating mode of the second communication phase, may be designed to switch the first and second terminals to input, and from the differential reception signal received at the first and second terminals to generate a nondifferential reception signal and output it to the communication control module.

For example, the communication control module is designed to generate the transmission signal in the first communication phase, using bits having a first bit time that is greater by at least a factor of 10 than a second bit time of bits that the communication control module generates in the transmission signal in the second communication phase.

Moreover, the above-mentioned object may achieved by a transceiver for a user station of a serial bus system in accordance with an example embodiment of the present invention. In accordance with an example embodiment of the present invention, the transceiver includes a transceiver module for transmitting a transmission signal onto a bus of the bus system, at least one first communication phase and one second communication phase being used in the bus system for exchanging messages between user stations of the bus system and for generating a digital reception signal from a signal that is received from the bus, an STB terminal for receiving an operating mode signaling signal from a communication control device that is designed to generate a transmission signal for transmission onto a bus of the bus system, and an operating mode decoding block for decoding the operating mode signaling signal, the operating mode signaling signal signaling to the transceiver into which operating mode the transceiver is to be switched as a function of the communication on the bus, or whether the transceiver is to be switched into the standby operating mode.

The transceiver yields the same advantages as stated above with regard to the communication control device. Advantageous further embodiments of the transceiver are described herein.

The operating mode decoding block may be designed to demodulate the operating modes from a pulse width modulation of the operating mode signaling signal. Additionally or alternatively, the operating mode decoding block may be designed to decode at least one of the operating modes from a bit pattern, in that the operating mode decoding block evaluates the 0 component in relation to the 1 component.

The transceiver described above may also include a first terminal for receiving a transmission signal from a communication control device in an operating mode of the first communication phase, a second terminal for transmitting the digital reception signal to the communication control device in the operating mode of the first communication phase, and an operating mode switching module for switching the transmission direction of the first and second terminals in the second communication phase in the same direction for a differential signal transmission via the first and second terminals.

In accordance with an example embodiment of the present invention, the operating mode switching module may be designed to switch the first and second terminals in a first operating mode of the second communication phase to input, and to generate a nondifferential transmission signal from the differential digital transmission signal received at the first and second terminals. Additionally or alternatively, the operating mode switching module, in a second operating mode of the second communication phase, may be designed to switch the first and second terminals to output and generate an inverse digital reception signal from the digital reception signal, and to output the digital reception signal to the second terminal and output the digital reception signal inverse thereto to the first terminal.

According to one exemplary embodiment of the present invention, the operating mode switching module is designed to generate and output the two reception signals to the two terminals at the same level in the second operating mode of the second communication phase for a predetermined time period in order to signal to the communication control device additional pieces of information which are in addition to pieces of information of the signals which in the bus system are exchanged with the messages between user stations of the bus system.

The transceiver module is optionally designed to transmit the transmission signal onto the bus as a differential signal.

The operating mode switching module may be designed to select the transmission direction of the first and second terminals as a function of the operating mode into which the transceiver is switched.

The devices described above also possibly include a direction control block for controlling the transmission direction of the first and second terminals as a function of the operating mode of the transceiver, a coding block for encoding the differential signals, a decoding block for decoding the differential signal at the first and second terminals into a nondifferential signal, and a multiplexer for outputting the nondifferential signal generated by the decoding block, when the transceiver is switched into an operating mode of the second communication phase.

According to one option, the signal received from the bus in the first communication phase is generated with a different physical layer than the signal received from the bus in the second communication phase.

It is possible that in the first communication phase, it is negotiated which of the user stations of the bus system in the subsequent second communication phase obtains, at least temporarily, exclusive, collision-free access to the bus.

The above-described communication control device and the above-described transceiver may be part of a user station of a bus system which also includes a bus and at least two user stations that are connected to one another via the bus in such a way that they may communicate serially with one another. At least one of the at least two user stations includes an above-described communication control device and an above-described transceiver.

Moreover, the object stated above may be achieved by a method for communicating in a serial bus system in accordance with an example embodiment of the present invention. In accordance with an example embodiment of the present invention, the method is carried out using a user station for a bus system in which at least one first communication phase and one second communication phase are used for exchanging messages between user stations of the bus system, the user station including an above-described communication control device and an above-described transceiver, and the method including the steps: generating, by use of an operating mode coding block, the operating mode signaling signal from a signal that signals to the transceiver that the transceiver is to be switched into the standby operating mode, and transmitting, using an STB terminal, the operating mode signaling signal to the transceiver, which is designed to transmit the transmission signal onto the bus of the bus system, the operating mode signaling signal signaling to the transceiver into which operating mode the transceiver is to be switched as a function of the communication on the bus, or whether the transceiver is to be switched into the standby operating mode.

The method yields the same advantages as stated above with regard to the communication control device and/or the transceiver.

Further possible implementations of the present invention also include combinations, even if not explicitly stated, of features or specific embodiments described above or discussed below with regard to the exemplary embodiments. Those skilled in the art will also add individual aspects as enhancements or supplements to the particular basic form of the present invention, in view of the present disclosure.

### BRIEF DESCRIPTION OF THE DRAWINGS

The present invention is described in greater detail below with reference to the figures, and based on exemplary embodiments.

FIG. 1 shows a simplified block diagram of a bus system according to a first exemplary embodiment of the present invention.

FIG. 2 shows a diagram for illustrating the design of messages that may be transmitted from user stations of the bus system according to the first exemplary embodiment of the present invention.

FIG. 3 shows a simplified schematic block diagram of a user station of the bus system according to the first exemplary embodiment of the present invention.

FIGS. 4 through 7 each show a temporal representation of signals or states at the user station from FIG. 3 when the user station is the transmitter of a message that is transmitted via a bus of the bus system.

FIGS. 8 through 11 each show a temporal representation of signals or states at the user station from FIG. 3 when the user station is the receiver of a message that is transmitted via the bus of the bus system.

FIGS. 12 through 15 each show a temporal representation of signals at the user station from FIG. 3 during the transmission of a frame, and the control of a standby operating mode when the user station in the data phase is the transmitter of a message that is transmitted via the bus of the bus system;

FIGS. 16 through 19 each show a temporal representation of signals at the user station from FIG. 3 during the reception of a frame, and the control of a standby operating mode when the user station in the data phase is the receiver of a message that is transmitted via the bus of the bus system.

FIGS. 20 through 24 each show a temporal representation of signals or states at the user station from FIG. 3 in a second exemplary embodiment, when the user station in the data phase is the transmitter of a message that is transmitted via the bus of the bus system, and switches back from the data phase into the arbitration phase.

Unless stated otherwise, identical or functionally equivalent elements are provided with the same reference numerals in the figures.

### DETAILED DESCRIPTION OF EXAMPLE EMBODIMENTS

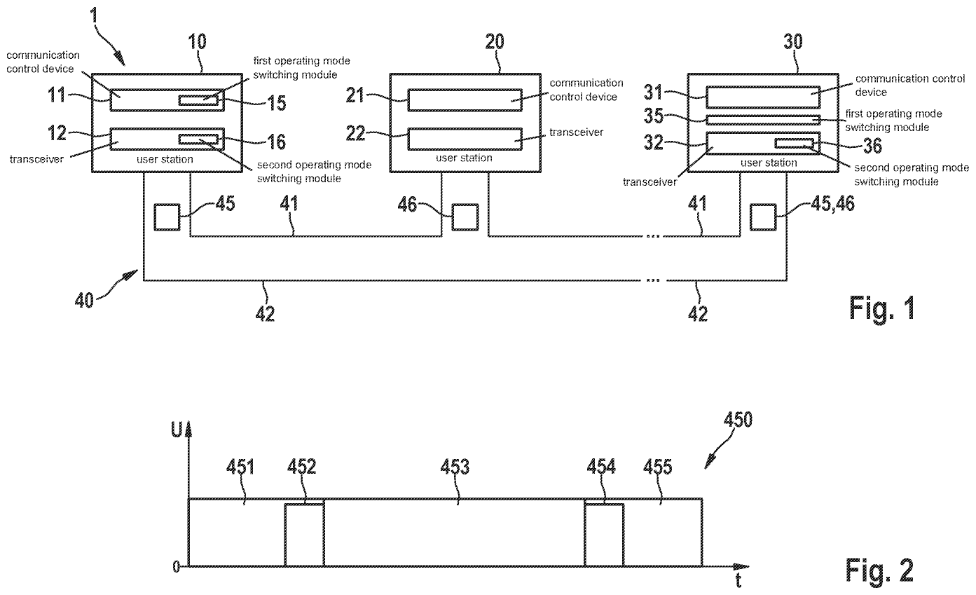

FIG. 1 shows as an example a bus system 1 that is in particular the basis for the design of a CAN bus system, a CAN FD bus system, a CAN FD successor bus system, and/or modifications thereof, as described below. The CAN FD successor bus system is referred to below as CAN XL. Bus system 1 may be used in a vehicle, in particular a motor vehicle, an aircraft, etc., or in a hospital, and so forth.

In FIG. 1, bus system 1 includes a plurality of user stations 10, 20, 30, each of which is connected to a first bus wire 41 and a second bus wire 42 at a bus 40. Bus wires 41, 42 may also be referred to as CAN_H and CAN_L, and are used for electrical signal transmission after coupling in the dominant levels or generating recessive levels for a signal in the transmission state. Messages 45, 46 in the form of signals are serially transmittable between individual user stations 10, 20, 30 via bus 40. User stations 10, 20, 30 are, for example, control units, sensors, display devices, etc., of a motor vehicle.

As shown in FIG. 1, user station 10 includes a communication control device 11, a transceiver 12, a first operating mode switching module 15, and a second operating mode switching module 16. In contrast, user station 20 includes a communication control device 21 and a transceiver 22. User station 30 includes a communication control device 31, a transceiver 32, a first operating mode switching module 35, and a second operating mode switching module 36. Transceivers 12, 22, 32 of user stations 10, 20, 30 are each directly connected to bus 40, although this is not illustrated in FIG. 1.

In each user station 10, 20, 30, messages 45, 46 are encoded in the form of frames via a TXD line and an RXD line, and are exchanged bit-by-bit between particular communication control device 11, 21, 31 and associated transceiver 12, 22, 32. This is described in greater detail below.

Communication control devices 11, 21, 31 are each used for controlling a communication of particular user station 10, 20, 30 via bus 40 with at least one other user station of user stations 10, 20, 30 connected to bus 40.

Communication control devices 11, 31 create and read first messages 45, which are modified CAN messages 45, for example, and also referred to below as CAN XL messages 45. CAN XL messages 45 are built up based on a CAN FD successor format, described in greater detail with reference to FIG. 2. Communication control devices 11, 31 may also be designed to provide a CAN XL message 45 or a CAN FD message 46 for transceivers 12, 32 or receive it from same, as needed. Communication control devices 11, 31 thus create and read a first message 45 or second message 46, first and second messages 45, 46 differing by their data transmission standard, namely, CAN XL or CAN FD in this case.

Communication control device 21 may be designed as a conventional CAN controller according to ISO 11898-1:2015, in particular as a CAN FD-tolerant conventional CAN controller or a CAN FD controller. Communication control device 21 creates and reads second messages 46, for example conventional CAN messages or CAN FD messages 46. CAN FD messages 46 may include a number from 0 to up to 64 data bytes, which in addition are transmitted at a much faster data rate than for a conventional CAN message. In the latter case, communication control device 21 is designed as a conventional CAN FD controller.

Except for the differences described in greater detail below, transceivers 12, 32 may be designed as CAN XL transceivers. Additionally or alternatively, transceivers 12, 32 may be designed as a conventional CAN FD transceiver. Transceiver 22 may be designed as a conventional CAN transceiver or as a CAN FD transceiver.

A formation and then transmission of messages 45 having the CAN XL format, in addition to the reception of such messages 45, is achievable by use of the two user stations 10, 30.

FIG. 2 shows for message 45 a CAN XL frame 450, which is transmitted from transceiver 12 or transceiver 32. For the CAN communication on bus 40, CAN XL frame 450 is divided into different communication phases 451 through 455, namely, an arbitration phase 451, a first changeover phase 452, a data phase 453, a second changeover phase 454, and a frame end phase 455.

In arbitration phase 451, for example at the start a bit is transmitted, which is also referred to as an SOF bit and which indicates the start of frame. An identifier including 11 bits, for example, for identifying the transmitter of message 45 is also transmitted in arbitration phase 451. During the arbitration, with the aid of the identifier, bit-by-bit negotiation is carried out between user stations 10, 20, 30 concerning which user station 10, 20, 30 would like to transmit message 45, 46 having the highest priority, and therefore for the next time period for transmitting in changeover phase 452 and subsequent data phase 453, obtains exclusive access to bus 40 of bus system 1.

In the present exemplary embodiment, in first changeover phase 452 preparation is made for the changeover from arbitration phase 451 into data phase 453. Changeover phase 452 may include a bit that has bit duration T_B1 of a bit of arbitration phase 451, and that is transmitted, at least in part, with the physical layer of arbitration phase 451. First changeover phase 452 logically belongs to arbitration phase 451. In particular, in this changeover phase 452, transceiver 12, 32 is signaled that device 12, 32 is to change into a different mode or operating mode, namely, into the physical layer of data phase 453.

In data phase 453, the bits of frame 450 having the physical layer of data phase 453 are transmitted which have a bit duration T_B2 that is shorter than bit duration T_B1 of a bit of arbitration phase 451. The useful data of CAN XL frame 450 or of message 45, among other things, are transmitted in data phase 453. The useful data may also be referred to as a data field of message 45. For this purpose, in data phase 453 a data length code that is 11 bits long, for example, may be transmitted after a data field identifier that identifies the type of content in the data field. The code may take on, for example, values from 1 to up to 2048, or some value by an increment of 1.

Alternatively, the data length code may include fewer or more bits, so that the value range and the increment may take on other values. The data length code is followed by further fields, for example the header check sum field. The useful data of CAN XL frame 450 or of message 45 are subsequently transmitted. At the end of data phase 453, a check sum of the data of data phase 453 and of the data of arbitration phase 451 may be contained in a check sum field, for example. The transmitter of message 45 may insert stuff bits as an inverse bit into the data stream in each case after a predetermined number of identical bits, in particular 10 identical bits. In particular, the check sum is a frame check sum F CRC via which all relevant bits of frame 450 up to the check sum field are verified. For example, stuff bits in data phase 453 are not verified, because these bits verify frame 450 itself and therefore are used for the error detection.

In the present exemplary embodiment, in second changeover phase 454 preparation is made for the changeover from data phase 453 into frame end phase 455. This means that a switch is made back into the transmission operating mode according to arbitration phase 451. Changeover phase 454 may include a bit that has bit duration T_B1 of a bit of arbitration phase 451, and that is transmitted with the physical layer of arbitration phase 451. However, distinguishing between a CAN XL frame or CAN frame or CAN FD frame is not necessary. Second changeover phase 454 logically belongs to frame end phase 455, in which the same transmission operating mode is used as in arbitration phase 451. In particular, in this second changeover phase 454, transceiver 12, 32 is signaled that device 12, 32 is to be changed into a different mode or operating mode, namely, into the physical layer of arbitration phase 451.

In frame end phase 455, after two bits AL2, AH2 at least one acknowledge bit ACK may be contained in an end field. This may be followed by a sequence of 7 identical bits that indicate the end of CAN XL frame 450. By use of the at least one acknowledge bit ACK, a receiver may communicate whether or not it has correctly received CAN XL frame 450 or message 45.

A physical layer, similarly as with CAN and CAN FD, is used at least in arbitration phase 451 and frame end phase 455. In addition, in changeover phases 452, 454 a physical layer, similarly as with CAN and CAN FD, may be used at least in part, i.e., during first changeover phase 452 at the start and during second changeover phase 454 at the end. The physical layer corresponds to the bit transmission layer or layer one of the conventional Open Systems Interconnection (OSI) model.

An important point during these phases 451, 455 is that the conventional CSMA/CR method is used, which allows simultaneous access of user stations 10, 20, 30 to bus 40 without destroying higher-priority message 45, 46. It is thus possible to add further bus user stations 10, 20, 30 to bus system 1 in a relatively simple manner, which is very advantageous.

Consequently, the CSMA/CR method must provide so-called recessive states on bus 40, which may be overwritten by other user stations 10, 20, 30 with dominant states on bus 40.

The arbitration at the start of a frame 450 or of message 45, 46, and the acknowledgement in frame end phase 455 of frame 450 or of message 45, 46 is possible only when the bit duration or bit time is much more than twice as long as the signal propagation time between two arbitrary user stations 10, 20, 30 of bus system 1. Therefore, the bit rate in arbitration phase 451 and in frame end phase 454 is selected to be slower than in data phase 453 of frame 450. In particular, the bit rate in phases 451, 455 is selected as 500 kbit/s, resulting in a bit duration or bit time of approximately 2 μs, whereas the bit rate in data phase 453 is selected as 5 to 10 Mbit/s or greater, resulting in a bit time of approximately 0.1 μs and shorter. The bit time of the signal in the other communication phases 451, 452, 454, 455 is thus greater than the bit time of the signal in data phase 453 by at least a factor of 10.

A transmitter of message 45, for example user station 10, starts a transmission of bits of changeover phase 452 and of subsequent data phase 453 onto bus 40 only after user station 10, as the transmitter, has won the arbitration, and user station 10, as the transmitter, thus has exclusive access to bus 40 of bus system 1. The transmitter may either switch to the faster bit rate and/or the other physical layer after a portion of changeover phase 452, or may switch to the faster bit rate and/or the other physical layer only with the first bit, i.e., at the start, of subsequent data phase 453.

In general, in the bus system with CAN XL, in comparison to CAN or CAN FD in particular the following differing properties may be achieved:
a) acquiring and optionally adapting proven properties that are responsible for the robustness and user-friendliness of CAN and CAN FD, in particular a frame structure including identifier and arbitration according to the CSMA/CR method,
b) increasing the net data transmission rate to approximately 10 megabits per second,
c) increasing the quantity of the useful data per frame to approximately 2 kbytes or an arbitrary value.

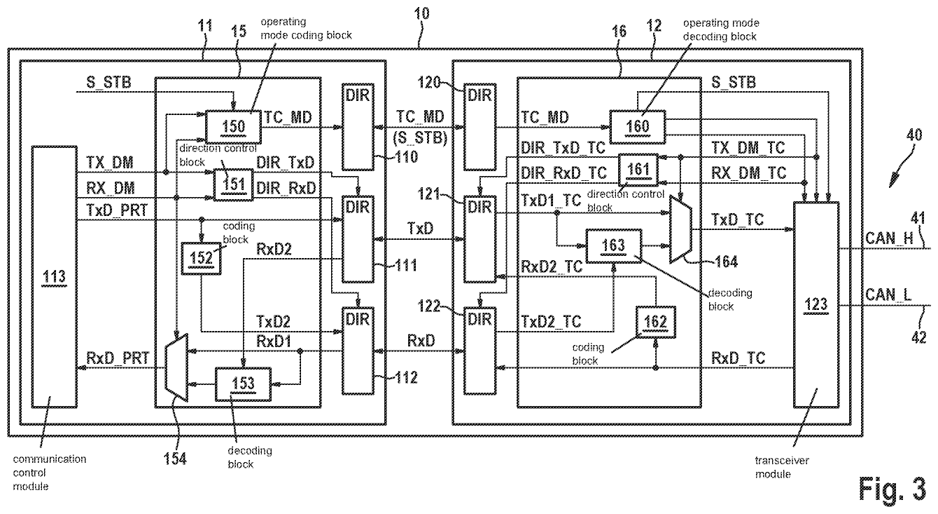

FIG. 3 shows the basic design of user station 10 together with communication control device 11, transceiver 12, and operating mode switching modules 15, 16. Operating mode switching module 15 of communication control device 11 has a design that is symmetrical with respect to operating mode switching module 16 of transceiver 12. Operating mode switching module 15 may also be referred to as a first operating mode switching module. Operating mode switching module 16 may also be referred to as a second operating mode switching module.

User station 30 has a design similar to that shown in FIG. 3, except that block 35 is not integrated into communication control device 31, but, rather, provided separately from communication control device 31 and transceiver 32. Therefore, user station 30 and block 35 are not separately described. The functions of operating mode switching module 15 described below are present in an identical form for operating mode switching module 35. The functions of operating mode switching module 16 described below are present in an identical form for operating mode switching module 36.

Alternatively or additionally, it is possible for block 16 to not be integrated into transceiver 12, but, rather, provided separately from communication control device 11 and transceiver 12.

Transceiver 12 is connected to bus 40, or more precisely, to its first bus wire 41 for CAN_H and its second bus wire 42 for CAN_L. During operation of bus system 1, transceiver 12 converts a transmission signal TxD of communication control device 11 into corresponding signals CAN_H and CAN_L for bus wires 41, 42, and transmits these signals CAN_H and CAN_L onto bus 40. Even though signals CAN_H and CAN_L are mentioned for transceiver 12, with regard to message 45 they are to be understood as signals CAN XL H and CAN XL L, which in data phase 453 differ from conventional signals CAN_H and CAN_L in at least one feature, in particular with regard to the formation of the bus states for the various data states of signal TxD and/or with regard to the voltage or the physical layer and/or the bit rate.

A difference signal VDIFF=CAN_H−CAN_L is formed on bus 40. With the exception of an idle or standby state, transceiver 12 with its receiver during normal operation always listens to a transmission of data or messages 45, 46 on bus 40, in particular regardless of whether or not user station 10 is the transmitter of message 45. Transceiver 12 forms a reception signal RxD from signals CAN_H and CAN_L that are received from bus 40, and passes it on to communication control device 11, as described in greater detail below.

The construction of user station 10 described below provides a robust, simple option for carrying out signaling for a changeover of the operating mode of transceiver 12 from communication control device 11 to transceiver 12. In addition, a robust, simple option is provided for symmetrically transmitting bits between communication control device 11 and transceiver 12 with the aid of signals, i.e., without the duration of the bits changing. This is a major advantage, in particular during the transmission of data during data phase 453 of a frame 450.

According to FIG. 3, in addition to operating mode switching module 15, communication control device 11 includes an STB terminal 110, a first bidirectional terminal 111 for a digital transmission signal TxD, a second bidirectional terminal 112 for a digital reception signal RxD, and a communication control module 113. In addition to operating mode switching module 16, transceiver 12 includes an STB terminal 120, a first bidirectional terminal 121 for digital transmission signal TxD, a second bidirectional terminal 122 for digital reception signal RxD, and a transceiver module 123.

STB terminal 110 is an output terminal of communication control device 11. STB terminal 120 is an input terminal of transceiver 12. Via STB terminal 110, communication control device 11 signals to transceiver 12 the changeover into a standby operating mode 457_B, which may also be referred to as a standby mode. In addition, via STB terminal 110, communication control device 11 signals to transceiver 12 the changeover into the other operating modes of transceiver 12, such as the changeover between an operating mode 451_B of arbitration phase 451, which may also be referred to as arbitration phase mode, and an operating mode 453_RX or an operating mode 453_TX. Operating mode 453_RX may also be referred to as RX data phase mode. Operating mode 453_TX may also be referred to as TX data phase mode. This is described in greater detail below.

Terminals 111, 112, 121, 122 are bidirectionally operable, namely, either as an output or an input, with the aid of modules 15, 16 and corresponding signals, as described below.

Communication control device 11 is designed as a microcontroller or includes a microcontroller. Communication control device 11 processes signals of an arbitrary application, for example a control unit for a motor, a safety system for a machine or a vehicle, or other applications. Not shown, however, is a system application-specific integrated circuit (ASIC), which alternatively may be a system base chip (SBC) on which multiple functions necessary for an electronics assembly of user station 10 are combined. Among other things, transceiver 12 and an energy supply device (not illustrated) that supplies transceiver 12 with electrical energy may be installed in the system ASIC. The energy supply device generally supplies a voltage CAN Supply of 5 V. However, depending on the requirements, the energy supply device may supply some other voltage having a different value and/or may be designed as a power source.

Communication control module 113 is a protocol controller that implements the CAN protocol, in particular the protocol for CAN XL or CAN FD. Communication control module 113 is designed to output the following output signals or to receive the following input signals.

Signal TxD_PRT is an output signal that corresponds to transmission signal TxD. Signal RxD_PRT is an input signal that corresponds to reception signal RxD.

In addition to these signals, communication control module 113 is designed to generate and output the following control signals: TX_DM, RX_DM.

Control signal TX_DM is an output signal, and indicates whether or not transceiver 12 is to operate in operating mode 453_TX or TX data phase mode. Operating mode 453_TX is also referred to as FAST_TX mode or first operating mode. In operating mode 453_TX or TX data phase mode, user station 10 has won the arbitration in arbitration phase 451, and in subsequent data phase 453 is the transmitter of frame 450. In this case user station 10 may also be referred to as a transmitting node. In operating mode TX data phase mode, transceiver 12 is to use the physical layer for data phase 453, and in the process, to drive bus wires CAN_H and CAN_L.

Control signal RX_DM is an output signal, and indicates whether or not transceiver 12 is to operate in operating mode 453_RX or RX data phase mode. The operating mode is also referred to as FAST_RX mode or second operating mode. In operating mode 453_RX or RX data phase mode, user station 10 has lost the arbitration in arbitration phase 451, and in subsequent data phase 453 is only the receiver, i.e., not the transmitter, of frame 450. In this case user station 10 may also be referred to as a receiving node. In operating mode RX data phase mode, transceiver 12 is to use the physical layer for data phase 453, but is not to drive bus wires CAN_H and CAN_L.

When the transceiver is neither in TX data phase mode nor in RX data phase mode, it is in the so-called arbitration phase mode, i.e., the mode or the operating mode that is used in arbitration phase 451 and frame end phase 455. In this mode, the physical layer via which dominant and recessive bus states may be transmitted is used.

Alternatively, the switching for signaling to transceiver 12 the operating mode that is to be switched on may take place via TxD terminal 111 and/or RxD terminal 112. The switching necessary for this purpose is not illustrated here.

Operating mode switching module 15 includes an operating mode coding block 150, a direction control block 151, a coding block 152, a decoding block 153, and a multiplexer 154. First operating mode switching module 15 receives the above-mentioned signals that are output by communication control module 113.

Operating mode coding block 150 receives a signal S_STB and control signals TX_DM, RX_DM of communication control module 113. Signal S_STB for the standby operating mode is generated by a component in communication control device 11, in particular a microcontroller.

Operating mode coding block 150 generates an operating mode signaling signal TC_MD as a function of these signals S_STB, TX_DM, RX_DM in order to be able to signal at least the stated state transitions between the various operating modes 451_B, 453_RX, 453_TX, 457_B. For this purpose, communication control device 12, in particular operating mode coding block 150, is designed to use signal S_STB and modulate it as signal TC_MD, using the pieces of information of signals TX_DM, RX_DM, to allow signaling of multiple state transitions. For example, various bit patterns signal various transitions between the operating modes of transceiver 12 (transceiver modes). Operating mode coding block 150 outputs operating mode signaling signal TC_MD to transceiver 12, more precisely, its terminal 120, via terminal 110. Transceiver 12 switches its operating mode as a function of the particular signaling of the operating mode in signal TC_MD.

Direction control block 151 generates switching signals DIR_TxD and DIR_RxD from control signals TX_DM, RX_DM of communication control module 113. Switching signal DIR_TxD controls direction DIR, more precisely, the transmission direction of first bidirectionally switchable terminal 111 of communication control device 11. In other words, switching signal DIR_TxD controls the direction of TxD terminal 111 of device 11. Switching signal DIR_RxD controls direction DIR, more precisely, the transmission direction of second bidirectionally switchable terminal 112 of communication control device 11. In other words, switching signal DIR_RxD controls the direction of RxD terminal 112 of device 11.

If signal TX_DM is set, in particular if its signal value is equal to 1, direction control block 151 generates switching signal DIR_TxD in such a way that the direction of TxD terminal 111 and the direction of RxD terminal 112 are switched to output. As a result, communication control module 113 may transmit a frame 450, to be transmitted onto bus 40, as a differential signal via terminals 111, 112, as described in greater detail below. In particular, communication control module 113 transmits a frame 450, and if signal TX_DM is set in the process, the direction of TxD terminal 111 and the direction of RxD terminal 112 are switched to output.

If signal RX_DM is set, in particular if its signal value is equal to 1, direction control block 151 generates switching signal DIR_RxD in such a way that the direction of TxD terminal 111 and the direction of RxD terminal 112 are switched to input. As a result, communication control module 113 may receive a frame 450, transmitted via bus 40, as a differential signal via terminals 111, 112, as described in greater detail below. In particular, communication control module 113 receives a frame 450, and if signal RX_DM is set in the process, the direction of TxD terminal 111 and the direction of RxD terminal 112 are switched to input.

Coding block 152 generates a signal TxD2 from signal TxD_PRT, i.e., transmission signal TxD. Signal TxD2 is an inverse signal with respect to signal TxD_PRT. Coding block 152 outputs signal TxD2 at terminal 112. If terminals 111, 112 are switched to output as described above, communication control device 11 may output signals TxD_PRT, TxD2 as a differential output signal to transceiver 12 via terminals 111, 112. In the simplest case, coding block 152 is an inverter that inverts signal TxD_PRT.

Decoding block 153 at its input is connected to terminals 111, 112. When terminals 111, 112 are switched to input as described above, decoding block 153 receives from terminals 111, 112 a differential input signal made up of a signal RxD1 and a signal RxD2. Decoding block 153 decodes signals RxD1, RxD2 to form nondifferential signal RxD_PRT. Decoding block 153 outputs signal RxD_PRT to multiplexer 154.

Communication control module 113 controls multiplexer 154 using control signal RX_DM. Depending on the signal value of control signal RX_DM, a selection is made as to whether communication control module 113 is provided with the signal that is decoded by decoding block 153, or with signal RxD1 from terminal 112, as signal RxD_PRT.

In transceiver 12, transceiver module 123 is designed to transmit and/or receive messages 45, 46 according to the CAN protocol, in particular messages according to the protocol for CAN XL or CAN FD as described above. Transceiver module 123 carries out the connection to the physical medium, i.e., the connection of bus 40 to bus wires 41, 42. Transceiver module 123 drives and decodes signals CAN_H and CAN_L for bus wires 41, 42 or bus 40. Transceiver module 123 is also designed to output subsequent output signals or to receive subsequent input signals.

Signal RxD_TC is an output signal that corresponds to a digital reception signal which transceiver module 123 generates from differential signal CAN_H, CAN_L from bus 40. Signal TxD_TC is an input signal that corresponds to transmission signal TxD, i.e., the signal that has been generated by communication control module 113 for transmission onto bus 40.

In addition to these signals, transceiver module 123 is designed to generate and output the following control signals: TX_DM_TC, RX_DM_TC.

Control signal TX_DM_TC is an input signal, and indicates whether or not transceiver 12 is to operate in or be switched into operating mode 453_TX or TX data phase mode in order to act in data phase 453 as a transmitter of frame 450, as described above. This is an operating mode in which transceiver module 123 transmits bits on bus 40, i.e., drives bus 40, in data phase 453.

Control signal RX_DM_TC is an input signal, and indicates whether or not transceiver 12 is to operate in or be switched into operating mode 453_RX or RX data phase mode in order to act in data phase 453 only as a receiver, i.e., not as a transmitter, of frame 450, as described above. This is an operating mode in which transceiver module 123 only receives bits from bus 40, i.e., does not drive bus 40, in data phase 453.

Second operating mode switching module 16 includes an operating mode decoding block 160, a direction control block 161, a coding block 162, a decoding block 163, and a multiplexer 164. Second operating mode switching module 16 receives the above-mentioned signals, which are output by transceiver module 123.

Operating mode decoding block 160 receives operating mode signaling signal TC_MD at its input, and from same forms control signals TX_DM_TC, RX_DM_TC, and S_STB for transceiver module 123. Operating mode decoding block 160 also outputs signal S_STB to transceiver module 123 for the standby operating mode. In particular, operating mode decoding block 160 demodulates operating mode signaling signal TC_MD in order to generate signals TX_DM_TC, RX_DM_TC, S_STB for transceiver module 123. Transceiver module 123 may thus switch its operating mode 451_B, 453_RX, 453_TX, 457_B corresponding to signals TX_DM_TC, RX_DM_TC, S_STB, as described above.

Direction control block 161 generates switching signals DIR_TxD_TC and DIR_RxD_TC from control signals TX_DM_TC, RX_DM_TC of transceiver module 123. Switching signal DIR_TxD_TC controls direction DIR, more precisely, the transmission direction of first bidirectionally switchable terminal 121 of transceiver 12. In other words, switching signal DIR_TxD_TC controls the direction of TxD terminal 121 of device 12. Switching signal DIR_RxD_TC controls direction DIR, more precisely, the transmission direction of second bidirectionally switchable terminal 122 of transceiver 12. In other words, switching signal DIR_RxD_TC controls the direction of RxD terminal 122 of device 12.

If signal RX_DM_TC is set, in particular if its signal value is equal to 1, direction control block 161 generates switching signal DIR_RxD_TC in such a way that the direction of TxD terminal 121 and the direction of RxD terminal 122 are switched to output. As a result, transceiver module 123 may transmit a frame 450, transmitted from a different user station via bus 40, as a differential signal to communication control device 11 via terminals 121, 122, as described in greater detail below. In particular, transceiver module 123 receives a frame 450, and if signal RX_DM_TC is set in the process, the direction of TxD terminal 121 and the direction of RxD terminal 122 are switched to output.

If signal TX_DM_TC is set, in particular if its signal value is equal to 1, direction control block 161 generates switching signal DIR_RxD_TC in such a way that the direction of TxD terminal 121 and the direction of RxD terminal 122 are switched to input. As a result, transceiver module 123 may receive a frame 450, to be transmitted onto bus 40, from communication control device 11 as a differential signal via transceiver terminals 121, 122. In particular, transceiver module 123 transmits a frame 450 onto bus 40, and if signal TX_DM_TC is set in the process, the direction of TxD terminal 121 and the direction of RxD terminal 122 are switched to input.

Coding block 162 generates a signal RxD2_TC from signal RxD_TC, i.e., reception signal RxD. Signal RxD2_TC is an inverse signal with respect to signal RxD_TC. Coding block 162 outputs signal RxD2_TC to terminal 121. When terminals 121, 122 are switched to output as described above, transceiver 12 may output signals RxD2_TC, RxD_TC, as a differential output signal, to communication control device 11 via terminals 121, 122. In the simplest case, coding block 162 is an inverter that inverts signal RxD_TC.

Decoding block 163 at its input is connected to terminals 121, 122. When terminals 121, 122 are switched to input as described above, decoding block 163 receives from terminals 121, 122 a differential input signal made up of a signal TxD1_TC and a signal TxD2_TC. Decoding block 163 decodes signals TxD1_TC, TxD2_TC to form nondifferential signal TxD_TC. Decoding block 163 outputs signal TxD_TC to multiplexer 154.

Transceiver module 123 controls multiplexer 164 using control signal TX_DM_TC. Depending on the signal value of control signal TX_DM_TC, a selection is made as to whether transceiver module 123 is provided with the signal that is decoded by decoding block 163, or with signal TxD1_TC from terminal 121, as signal TxD_TC.

Consequently, in operating mode 453_TX or TX data phase mode as described above, communication control device 11 transmits the bit stream of serial transmission signal TxD as a differential signal via TxD and RxD terminals 111, 112. Transceiver 12 receives this differential signal at its TxD and RxD terminals 121, 122, and decodes this differential signal to form a nondifferential signal TxD_TC.

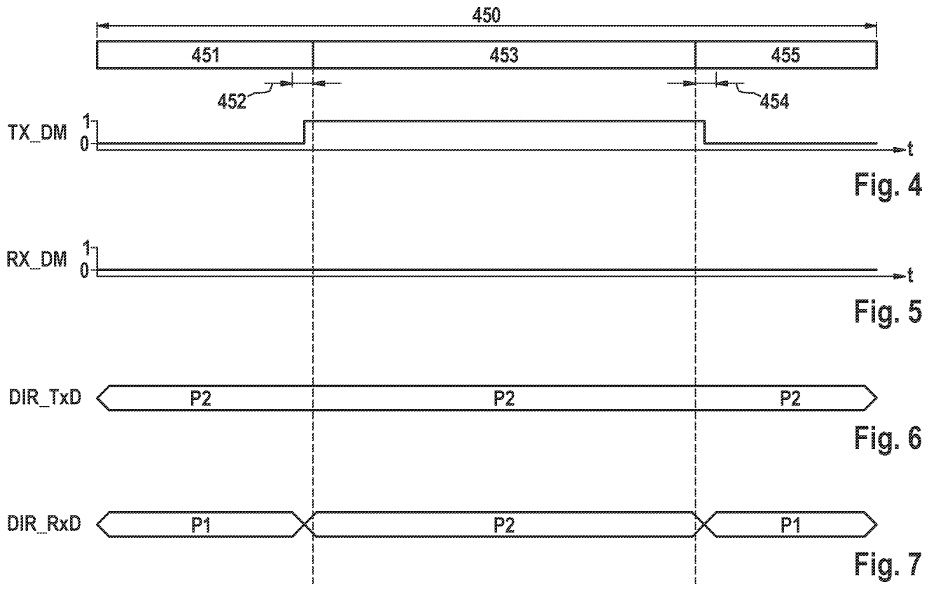

FIGS. 4 through 7 show an example of the signal patterns of the above-described signals in communication control device 11 when user station 10 is the transmitter of message 45, and transceiver 12 is thus switched into operating mode 453_TX or TX data phase mode in data phase 453. In FIGS. 6 and 7, reference symbol P1 stands for input, and reference symbol P2 stands for output.

According to FIGS. 4 through 7, communication control device 11 and transceiver 12 use terminals 111, 112, 121, 122 of user station 10, as customary, for transmitting the data during arbitration phase 451. Communication control device 11 transmits with the aid of TxD terminal 111, and at the same time receives the data from bus 40 with the aid of RxD terminal 112.

In faster operating mode 453_TX of transceiver 12, user station 10 transmits solely as a transmitting node, i.e., does not receive the signal from bus 40, as shown in FIGS. 4 through 7.

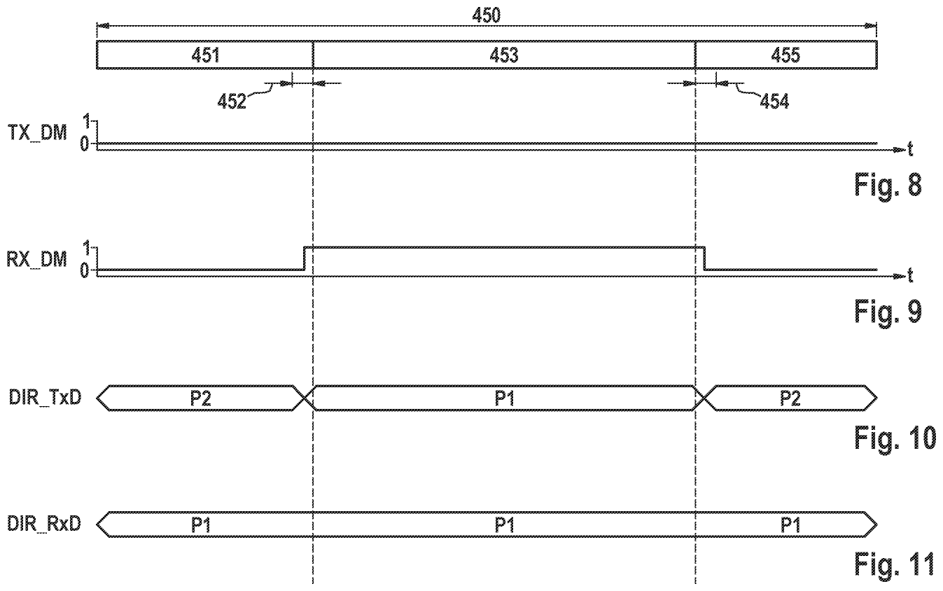

In addition, user station 10 receives solely as a receiving node in faster operating mode 453_RX of transceiver 12, as shown in FIGS. 8 through 11. FIGS. 8 through 11 show an example of the signal patterns of the above-described signals in communication control device 11 when user station 10 is not a transmitter of the message, and transceiver 12 is thus switched into operating mode 453_RX or RX data phase mode. In FIGS. 10 and 11 as well, reference symbol P1 stands for input and reference symbol P2 stands for output. Consequently, in operating mode 453_RX or RX data phase mode as described above, transceiver 12 transmits the bit stream of serial reception signal RxD as a differential signal via TxD and RxD terminals 121, 122. Communication control device 11 receives this differential signal at its TxD and RxD terminals 111, 112, and decodes this differential signal to form nondifferential signal RxD_PRT. In addition, the transmission of the data during arbitration phase 451 and frame end phase 455 takes place via terminals 111, 112, 121, 122, as described above for FIGS. 4 through 7.

Thus, in contrast to phases 451, 455 of a frame 450 and in contrast to CAN FD, for user stations 10, 30 in data phase 453 the simultaneous transmission and reception on CAN bus 40 in operating modes 453_RX, 453_TX, or RX data phase mode, TX data phase mode of transceiver 12 is no longer necessary. During the time in which transceiver 12 is in an operating mode of data phase 453, communication control device 11 and transceiver 12 use the two terminals 111, 112, 121, 122 for signals RxD, TxD in the same direction in order to transmit a differential transmission signal TxD (first operating mode of data phase 453) or a differential reception signal RxD (second operating mode of data phase 453).

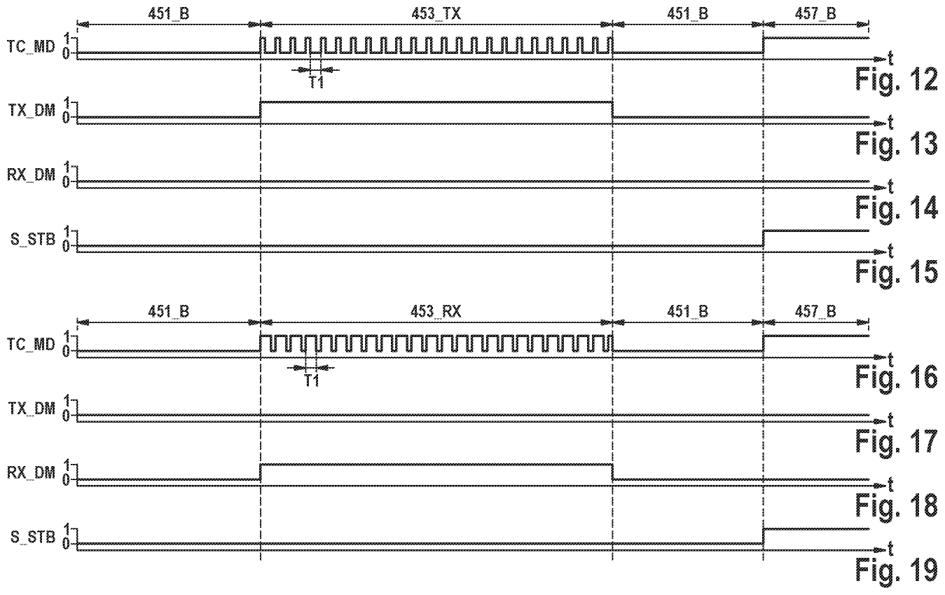

FIGS. 12 through 15 show an example of the signal patterns of above-described signals TC_MD, TX_DM, RX_DM, and of signal S_STB in communication control device 11 when user station 10 is the transmitter of the message, and transceiver 12 is thus switched from operating mode 451_B of arbitration phase 451 into operating mode 453_TX or TX data phase mode, and is subsequently switched back into operating mode 451_B of arbitration phase 451.

Operating mode signaling signal TC_MD in FIG. 12 shows an example of an encoding of the various operating modes for transceiver 12, in particular its transceiver module 123. Operating mode coding block 150 is thus designed to encode operating modes 451_B, 453_TX, 453_RX, 457_B not using events, but, rather, as a status in operating mode signaling signal TC_MD.

If control signals TX_DM, RX_DM, and S_STB are all 0, as shown in FIGS. 13, 14, and 15 or in FIGS. 17, 18, and 19, transceiver 12, in particular its transceiver module 123, is to operate in operating mode 451_B of arbitration phase 451 (arbitration phase mode). In this case, TC_MD=0 for a duration longer than a predetermined time period T1, as shown in FIG. 12 or FIG. 16.

If control signal TX_DM=1 and control signal RX_DM=0, as shown in FIGS. 13 and 14, transceiver 12, in particular its transceiver module 123, is to operate in operating mode 453_TX or TX data phase mode. In this case, TC_MD=pulse width modulation (PWM) signal or a bit pattern having a greater 0 component than a 1 component, as shown in FIG. 12. The maximum duration of a 0 pulse is less than or equal to predetermined time period T1.

If control signal TX_DM=0 and control signal RX_DM=1, as shown in FIGS. 17 and 18, transceiver 12, in particular its transceiver module 123, is to operate in operating mode 453_RX or RX data phase mode. In this case, TC_MD=PWM signal or a bit pattern having a greater 1 component than a 0 component, as shown in FIG. 16. The maximum duration of a 1 pulse is less than or equal to predetermined time period T1.

If transceiver 12, in particular its transceiver module 123, is to go into standby operating mode 457_B (standby mode) or remain in this operating mode 457_B, TC_MD=1 for a duration longer than predetermined time period T1. The user station does not transmit frames 450 on bus 40 in standby operating mode 457_B (standby mode).

Predetermined time period T1 may be 200 ns long, for example. This is long enough for a cost-effective implementation, and also short enough to allow signaling of a changeover within an arbitration bit (at least 1000 ns long).

In general, the 0 component in relation to the 1 component in signal TC_MD may indicate the various operating modes (451_B; 453_TX; 453_RX; 457_B) in which transceiver 12, in particular its transceiver module 123, is to switch. In addition, block 150 may be designed to use arbitrary combinations of the above-mentioned options for encoding the operating modes in signal TC_MD.

Terminal 110 may replace the STB pin in devices 11, 12 that are presently commonly used.

According to a first modification of the above-mentioned embodiment of modules 15, 16, it is possible for at least one of modules 15, 16 to allow switching only into operating mode 453_TX or TX data phase mode. Such a variant may be advantageous, for example, for a user station 10, 20 of bus system 1 which itself only has to transmit signals, but does not have to receive signals from bus 40, in order to carry out its function. One example of the design of such a user station is a strict actuator whose control is transmitted via bus 40, but which receives or generates the event for the control independently of the communication at the bus.

According to a second modification of the above-mentioned embodiment of modules 15, 16, it is possible for at least one of modules 15, 16 to allow switching only into operating mode 453_RX or RX data phase mode. Such a variant may be advantageous, for example, for a user station 10, 20 of bus system 1 which itself does not have to transmit signals, but instead only has to receive signals from bus 40, in order to carry out its function. One example of the design of such a user station is a transmitter, in particular a rev transmitter, an actuator, etc.

Of course, the above-described functions of devices 11, 12 are also usable for some other modification of CAN FD and/or CAN, at least for transmitting the useful data.

As a result of the design of user station 10, a galvanic connection via an additional terminal in each case at communication control device 11 and transceiver 12 connected thereto is not necessary in order for communication control device 11 to be able to signal to transceiver 12 that the changeover into a different operating mode of transceiver 12 is to be made. Additionally or alternatively, an additional terminal at communication control device 11 and transceiver 12 connected thereto also is not necessary to be able to ensure the symmetry of the data transmission between devices 11, 12. This means that an additional terminal, which is not available at a standard housing of devices 11, 12, is advantageously not necessary. Changing to another housing that is larger and expensive in order to provide an additional terminal is thus not necessary.

Due to the described design of device(s) 11, 12, 32, 35, much higher data rates may be achieved in data phase 453 than with CAN or CAN FD. In addition, the data length in the data field of data phase 453 may be arbitrarily selected, as described above. As a result, the advantages of CAN with regard to the arbitration may be retained, yet a higher volume of data may be transmitted very reliably and thus effectively, in a shorter time period than previously.

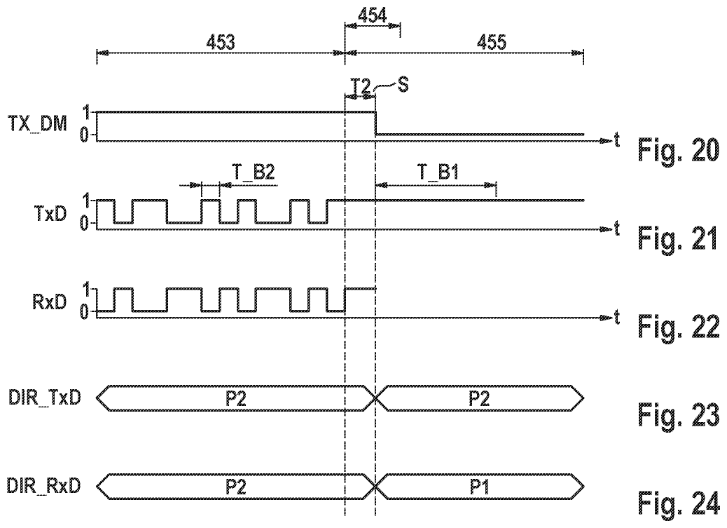

FIGS. 20 through 24 show signal patterns for user station 10 in a second exemplary embodiment. The transition between data phase 453 and frame end phase 455 when user station 10 is the transmitter of frame 450 is shown. In frame end phase 455, the transmission operating mode corresponds to arbitration phase 451. According to FIG. 23, communication control device 11 transmits in frame end phase 455 with the aid of TxD terminal 111, so that terminal 111 is set to output (reference symbol P2), and at the same time receives the data from bus 40 with the aid of RxD terminal 112, so that terminal 111 is set to input (reference symbol P1) as shown in FIG. 24.

However, during operating mode 453_TX or TX data phase mode in data phase 453, communication control device 11 uses its two terminals 111, 112 as output (reference symbol P2 in FIGS. 23 and 24), and transceiver 12 uses its two terminals 121, 122 as input (reference symbol P1). As a result, terminals 111, 112 transmit a differential signal TxD_PRT, TxD2 to terminals 121, 122 in data phase 453, denoted by reference symbols TxD, RxD in FIGS. 21 and 22. According to FIG. 21, signal TxD at terminal 111 includes bits having a bit duration T_B2. According to FIG. 22, signal RxD at terminal 112 likewise includes having bit duration T_B2, since it corresponds to the inverse TxD signal.

If a changeover is to be made from operating mode 453_TX or TX data phase mode in data phase 453 into the operating mode of arbitration phase 451, the arbitration phase mode, in which signals TxD, RxD are transmitted with a bit duration T_B1 (FIG. 21), operating mode switching module 15 is designed to transmit a nondifferential signal via its two terminals 111, 112 in order to signal the changeover, as shown in FIGS. 21 and 22. For this purpose, in changeover phase 454, for example operating mode switching module 15 transmits signals TxD=RxD=1 as signaling S via its two terminals 111, 112 for a predetermined second time period T2, as shown in FIGS. 21 and 22. Predetermined second time period T2 is at least T=100 ns, for example. Transceiver 12 may thus recognize that transceiver 12 is now to switch its operating mode into the operating mode of arbitration phase 451.

In the example described above, signaling S takes place for the changeover while CAN bus 40 is on the “data 1” or “recessive” level. Thus, no conflict or short circuit arises at RxD terminal 112, 122 when transceiver 12 begins to drive the RxD line between transceiver 12 and communication control device 11. If signaling S for changing over the operating mode of transceiver 12 is to take place on CAN bus 40 at the inverse level, communication control device 11 is designed to carry out signaling S for the changeover by transmitting levels TxD=RxD=0.

In contrast to the changeover to frame end phase 455, in the present exemplary embodiment a signaling of the operating mode change from arbitration phase 451 into data phase 453, i.e., into one of operating modes RX data phase mode, TX data phase mode of transceiver 12, may take place via RxD terminal 112. For this purpose, communication control device 11 drives RxD terminal 112 for a short period for the purpose of signaling the operating mode change more strongly than transceiver 12 drives its RxD terminal 122. This avoids the situation of the value of the RxD line possibly being indeterminate when communication control device 11 drives its RxD terminal 112 and transceiver 12 also drives its RxD terminal 122, resulting in a superimposition of the two signal sources at terminals 112, 122. In the event of such a superimposition of the two signal sources at terminals 112, 122, communication control device 11 thus always prevails. The value of the RxD line is therefore always certain.

In addition, the second exemplary embodiment thus has the advantage that a further terminal or pin or port for devices 11, 12 is not necessary, so that the approach is very cost-effective.

Otherwise, the communication in user stations 10, 30 and in bus system 1 may take place as described for the first exemplary embodiment.

According to a third exemplary embodiment, transceiver 12 and/or transceiver 32, in particular operating mode changeover module 16, may be designed to signal something to communication control device 11, in particular communication control module 113, upon receipt in operating mode 453_RX or RX data phase mode. For this purpose, transceiver 12, 32 transmits a nondifferential signal via TxD and RxD terminals 121, 122 in an additional operating mode of data phase 453, as described for the second exemplary embodiment for terminals 111, 112. For example, as signaling S, transceiver 12, 32 may transmit the following levels at terminals 121, 122: TxD=RxD=1.

Signaling S to transceivers 12, 32 may contain or be additional pieces of information which are in addition to pieces of information of the signals which in bus system 1 are exchanged with messages 45, 46 between user stations 10, 30 of bus system 1. The additional pieces of information allow an internal communication of devices 11, 12 or of devices 31, 32.

Otherwise, the communication in user stations 10, 30 and in bus system 1 may take place as described for the first or second exemplary embodiment.

All of the above-described embodiments of devices 11, 12, 31, 32, of modules 15, 16, 35, 36, of user stations 10, 20, 30 of bus system 1, and of the method carried out therein may be used alone or in any possible combination. In particular, all features of the above-described exemplary embodiments and/or modifications thereof may be arbitrarily combined. Additionally or alternatively, in particular the following modifications are possible.

Although the present invention is described above with the example of the CAN bus system, the present invention may be employed for any communications network and/or communication method in which two different communication phases are used in which the bus states, which are generated for the different communication phases, differ. In particular, the above-described principle of the present invention is usable for interfaces which for various communication phases require a changeover signal from a protocol controller or module 113, and/or that require a data exchange between devices 11, 12.

Above-described bus system 1 according to the exemplary embodiments is described with reference to a bus system based on the CAN protocol. However, bus system 1 according to the exemplary embodiments may also be some other type of communications network in which data are serially transmittable at two different bit rates. It is advantageous, but not a mandatory requirement, that in bus system 1, exclusive, collision-free access of a user station 10, 20, 30 to a shared channel is ensured, at least for certain time periods.

The number and arrangement of user stations 10, 20, 30 in bus system 1 of the exemplary embodiments is arbitrary. In particular, user station 20 in bus system 1 may be dispensed with. It is possible for one or more of user stations 10 or 30 to be present in bus system 1. It is possible for all user stations in bus system 1 to have the same design, i.e., for only user station 10 or only user station 30 to be present.

What is claimed is:

1. A communication control device for a user station of a serial bus system, comprising:
a communication control module configured to generate a transmission signal for controlling a communication of the user station with at least one other user station of the bus system, in which bus system at least one first communication phase and one second communication phase are used for exchanging messages between user stations of the bus system;
an STB terminal configured to transmit an operating mode signaling signal to a transceiver configure to transmit the transmission signal onto a bus of the bus system; and
an operating mode coding block configured to generate the operating mode signaling signal from a signal that signals to the transceiver that the transceiver is to be switched into a standby operating mode, the operating mode signal signaling to the transceiver an operating mode into which the transceiver is to be switched as a function of the communication on the bus, or whether the transceiver is to be switched into the standby operating mode.

2. The communication control device as recited in claim 1, wherein the operating mode coding block is configured to encode operating modes as a state in the operating mode signaling signal.

3. The communication control device as recited in claim 2, wherein the operating mode coding block is configured to modulate at least one of the operating modes in the operating mode signaling signal using pulse width modulation.

4. The communication control device as recited in claim 2, wherein the operating mode coding block is configured to encode at least one of the operating modes in the operating mode signaling signal as a bit pattern in which a 0 component in relation to a 1 component indicates the operating mode.

5. The communication control device as recited in claim 1, further comprising:
a first terminal configured to transmit the transmission signal to the transceiver in an operating mode of the first communication phase;
a second terminal configured to receive a digital reception signal from the transceiver in the operating mode of the first communication phase; and
an operating mode switching module configured to switch a transmission direction of the first and second terminals in the second communication phase in the same direction for a differential signal transmission via the first and second terminals.

6. The communication control device as recited in claim 5, wherein: (i) the operating mode switching module, in a first operating mode of the second communication phase, is configured to switch the first and second terminals to output and generate an inverse digital transmission signal from the transmission signal, and to output the transmission signal at the first terminal, and to output the digital transmission signal inverse thereto at the second terminal, and/or (ii) the operating mode switching module, in a second operating mode of the second communication phase, is configured to switch the first and second terminals to input, and from the differential reception signal received at the first and second terminals to generate a nondifferential reception signal and output it to the communication control module.

7. The communication control device as recited in claim 1, wherein the communication control module is configured to generate the transmission signal in the first communication phase, using bits having a first bit time that is greater by at least a factor of 10 than a second bit time of bits that the communication control module generates in the transmission signal in the second communication phase.

8. A transceiver for a user station of a serial bus system, comprising:
a transceiver module configured to transmit a transmission signal onto a bus of the bus system in which bus system at least one first communication phase and one second communication phase are used for exchanging messages between user stations of the bus system, and to generate a digital reception signal from a signal that is received from the bus;
an STB terminal configured to receive an operating mode signaling signal from a communication control device which is configured to generate a transmission signal for transmission onto a bus of the bus system; and
an operating mode decoding block configured to decode the operating mode signaling signal, the operating mode signaling signal signaling to the transceiver into which operating mode the transceiver is to be switched as a function of a communication on the bus, or whether the transceiver is to be switched into a standby operating mode.

9. The transceiver as recited in claim 8, wherein: (i) the operating mode decoding block is configured to demodulate operating modes from a pulse width modulation of the operating mode signaling signal, and/or (ii) the operating mode decoding block is configured to decode at least one of the operating modes from a bit pattern, in that the operating mode decoding block evaluates a 0 component in relation to a 1 component.

10. The transceiver as recited in claim 8, further comprising:
a first terminal configured to receive a transmission signal from a communication control device in an operating mode of the first communication phase;
a second terminal configured to transmit the digital reception signal to the communication control device in the operating mode of the first communication phase; and
an operating mode switching module configured to switch a transmission direction of the first and second terminals in the second communication phase in the same direction for a differential signal transmission via the first and second terminals.

11. The transceiver as recited in claim 10, wherein: (i) the operating mode switching module is configured to switch the first and second terminals in a first operating mode of the second communication phase to input, and to generate a nondifferential transmission signal from the differential digital transmission signal received at the first and second terminals, and/or (ii) the operating mode switching module, in a second operating mode of the second communication phase, is configured to switch the first and second terminals to output, and to generate an inverse digital reception signal from the digital reception signal and to output the digital reception signal to the second terminal, and to output the digital reception signal inverse thereto to the first terminal.

12. The transceiver as recited in claim 8, wherein the operating mode switching module is configured to generate and output the digital reception signal and the inverse digital reception system to the first and second terminals at the same level in the second operating mode of the second communication phase for a predetermined time period to signal to the communication control device additional pieces of information which are in addition to pieces of information of signals which in the bus system are exchanged with messages between user stations of the bus system.

13. The transceiver as recited in claim 8, wherein the transceiver module is designed to transmit the transmission signal onto the bus as a differential signal.

14. The communication control device as recited in claim 5, wherein the operating mode switching module is configured to select the transmission direction of the first and second terminals as a function of the operating mode into which the transceiver is switched.

15. The transceiver as recited in claim 10, wherein the operating mode switching module is configured to select the transmission direction of the first and second terminals as a function of the operating mode into which the transceiver is switched.

16. The communication control device as recited in claim 14, wherein the operating mode switching module includes:
a direction control block configured to control the transmission direction of the first and second terminals as a function of the operating mode of the transceiver;
a coding block configured to encode differential signals;
a decoding block configured to decode a differential signal at the first and second terminals into a nondifferential signal; and
a multiplexer configured to output the nondifferential signal generated by the decoding block, when the transceiver is switched into an operating mode of the second communication phase.

17. The communication control device as recited in claim 14, wherein a signal received from the bus in the first communication phase is generated with a different physical layer than the signal received from the bus in the second communication phase, and in the first communication phase, it is negotiated which of the user stations of the bus system in a subsequent second communication phase obtains, at least temporarily, exclusive, collision-free access to the bus.

18. A bus system, comprising:
a bus; and
at least two user stations that are connected to one another via the bus in such a way that they may communicate serially with one another, and of which at least one of the user stations includes:
a communication control device including:
a communication control module configured to generate a transmission signal for controlling a communication of the user station with at least one other user station of the bus system, in which bus system at least one first communication phase and one second communication phase are used for exchanging messages between user stations of the bus system,
an first STB terminal configured to transmit an operating mode signaling signal to a transceiver configure to transmit the transmission signal onto a bus of the bus system, and
an operating mode coding block configured to generate the operating mode signaling signal from a signal that signals to the transceiver that the transceiver is to be switched into a standby operating mode, the operating mode signal signaling to the transceiver an operating mode into which the transceiver is to be switched as a function of the communication on the bus, or whether the transceiver is to be switched into the standby operating mode; and
a transceiver including:
a transceiver module configured to transmit a transmission signal onto a bus of the bus system, and to generate a digital reception signal from a signal that is received from the bus;
an second STB terminal configured to receive the operating mode signaling signal from the communication control device; and
an operating mode decoding block configured to decode the operating mode signaling signal, the operating mode signaling signal signaling to the transceiver into which operating mode the transceiver is to be switched as a function of the communication on the bus, or whether the transceiver is to be switched into a standby operating mode.

19. A method for communicating in a serial bus system, the method being carried out using a user station for a bus system in which at least one first communication phase and one second communication phase are used for exchanging messages between user stations of the bus system, the user station including a communication control device and a transceiver, the method comprising the following steps:
generating, by use of an operating mode coding block of the communication control device, an operating mode signaling signal from a signal that signals to the transceiver that the transceiver is to be switched into a standby operating mode; and
transmitting, using an STB terminal, the operating mode signaling signal to the transceiver, which is configured to transmit the transmission signal onto a bus of the bus system, the operating mode signaling signal signaling to the transceiver into which operating mode the transceiver is to be switched as a function of a communication on the bus, or whether the transceiver is to be switched into the standby operating mode.
